(19) United States
(12) Patent Application Publication
(10) Pub. No.: US 2023/0115100 A1
(43) Pub. Date: Apr. 13, 2023

(54) CONSUMER GOODS MADE WITH PIECES OF VERTICALY LAPPED NONWOVEN

(71) Applicant: Piana Nonwovens LLC, Cartersville, GA (US)

(72) Inventors: Sang-hoon Lim, Cartersville, GA (US); Yang Yu, Cartersville, GA (US); Eric McCann, Cartersville, GA (US); Ariel Guerra, Catersville, GA (US); Andrea Piana, Cartersville, GA (US)

(21) Appl. No.: 17/935,625

(22) Filed: Sep. 27, 2022

Related U.S. Application Data
(60) Provisional application No. 63/252,230, filed on Oct. 5, 2021.
(60) Provisional application No. 63/291,497, filed on Dec. 20, 2021.
(60) Provisional application No. 63/352,790, filed on Jun. 16, 2022.

(51) Int. Cl. A47G 9/10; A47G 9/00

(52) U.S. Cl. CPC A47G 9/10; A47G 9/007; A47G 2009/1018

(57) ABSTRACT

Consumer products such as pillows for bedding or furniture, sack-like furniture, toppers for car seats, office seats, or household seats, and pet mattresses, are constructed from an outer casing, such as a woven or knitted fabric or a quilted fabric which may include a cushioning layer and a plurality of cut pieces of vertically lapped nonwoven material. The outer casing may be sewn closed but preferably includes a zippered opening or other opening which can be selectively opened and closed to allow the consumer to add or subtract cut pieces of vertically lapped nonwoven material from the interior volume of the outer casing. A zippered inner layer may neatly hold all of the cut pieces of vertically lapped nonwoven material together while the outer casing is changed or cleaned.

### CROSS-REFERENCE TO RELATED APPLICATIONS

This application claims priority to each of U.S. Ser. No. 63/252,230 filed on Oct. 5, 2021, U.S. Ser. No. 63/291,497 filed on Dec. 20, 2021, and U.S. Ser. No. 63/352,790 filed on Jun. 16, 2022, and the complete contents of each is herein incorporated by reference.

### FIELD OF THE INVENTION

The invention generally relates to the use of pieces cut from vertically lapped nonwoven as a filling material for consumer goods, and particularly consumer goods that might otherwise use shredded foam as filling material. Those goods include but are not limited to pillows, cushions, sacks, bean bags, and pet mattresses, etc.

### BACKGROUND

A nonwoven is a fabric like material where web structures are bonded together by entangling fibers or filaments, and joining adjacent fibers or filaments at random points mechanically, thermally or chemically. They are flat or tufted porous sheets that are made from separate fibers, molten plastic, or plastic film. They are not made by weaving or knitting and do not require conversion of the fibers to yarn. Manufacturing of nonwoven products is well described in “Nonwoven Textile Fabrics” in Kirk-Othmer Encyclopedia of Chemical Technology, 3rd Ed., Vol. 16, July 1984, John Wiley & Sons, p. 72˜124 and in “Nonwoven Textiles”, November 1988, Carolina Academic Press. Web bonding methods include mechanical bonding (e.g., needle punching, stitching, and hydro-entanglement), chemical bonding using binder chemicals (e.g., saturation, spraying, screen printing, and foam), and thermal bonding using binder fibers with low-melting points. Two common thermal bonding methods are air heating and calendaring. In air heating, hot air fuses low-melt binder fibers within and on the surface of the web to make high-loft nonwoven. In the calendaring process, the web is passed and compressed between heated cylinders to produce a low-loft nonwoven.

A vertically lapped (V-Lap) nonwoven is a type of nonwoven material where at least one layer is folded into a plurality of folds to form a pleated structure. FIG. 1 shows a schematic side view of a V-Lap structure 10 which is composed of a series of folds. Due to its vertical fiber arrangement, V-Lap nonwovens provide better resilience and shape recovery to compression compared to cross lapped nonwovens. V-Lap nonwovens are produced by commercially available machines, such as V-Lap vertical lapping systems sold by V-Lap Pty Ltd. and by Struto International, Inc. In the V-Lap system, staple fiber blend including binder fibers are opened, blended, and carded. The carded fiber web is pleated and the fibers are bonded mechanically (needling) and thermally to produce vertically lapped nonwovens. In the Struto system, the carded fiber web containing binder fiber is fed into the Struto lapping device. The vertical lapper then folds the web into a uniform structure. The folds are compressed together into a continuous structure, which is held in vertical position as it passes the heated thermal bonding oven.

When nonwovens are made with elastomeric binder fibers and high resilience fibers, it provides a better resilience to the nonwovens. Examples of the elastomeric polyester binder fibers include but are not limited to ELK®, E-PLEX®, and EMF type high elastic LMF that are commercially available from Teijin Limited, Toray Chemical Korea Inc., and Huvis Corporation, respectively. Elastomeric polyester binder fiber provides an elastic property to the nonwoven and provide bonding between fibers after the thermal bonding process. To provide bulkiness and resilience to the nonwoven, hollow conjugate polyester fiber can be used together with binder fibers, such as the elastomeric binder polyester fiber, conventional binder fibers, or any combination of these. In addition to these fibers, other fibers can be used to give other required functions. Other fibers include but not limited to man-made (e.g., rayon, lyocell, Nylon, Kevlar, etc.) and/or natural fibers (e.g., cotton, jute, silk, wool, linen, cashmere, etc.). Exemplary types of polyesters include but are not limited to PET (polyethylene terephthalate), PTT (polytrimethylene terephthalate), and PBT (polybutylene terephthalate). The most commonly used polyester is PET.

Shredded foam is used as a filler material for pillows and other products. Such products are widely available from Amazon and other sources. An advantage of these products is that they are often designed for the consumer to remove pieces of foam, or add pieces of foam to the pillow, to suit the support and softness desired by the individual user. The foam can be accessed through a zipper on the pillow case. A problem with foam is that it tends to absorb and retain heat. Another problem with foam is it tends to be heavier than is desired.

### SUMMARY

In an embodiment of the invention, cut up pieces of V-Lap nonwoven material are used as a filler material for consumer goods such as pillows, cushions, sacks, bean bags, and pet mattresses.

According to the invention, cut up pieces of V-Lap nonwoven material are lighter in weight than foam, and provide for improved air flow and thus for a “cooler” sleep or comfort than foam. In some embodiments, the pillow case can include a sheet of V-Lap nonwoven material or can be formed from a quilted material that includes a sheet of V-lap nonwoven. This tends to make the pillow or other consumer product less bumpy feeling to the user. In other embodiments, the cut up pieces of V-Lap nonwoven material can be housed within a separate liner that fits within the pillow case. This allows the pillow case to be separated from the filling material for cleaning purposes, while retaining the filling material together inside a separate fillable liner.

The consumer products according to the invention can have widely varying applications. For example, they can be used on bedding, but may also serve as the back or cushion on a sofa, as well as in other applications, e.g., sack-like furniture, toppers for car seats and household seats, and pet mattress, etc. The invention may be used in any application where a pillow is used, and where the light weight and breathability benefits of vertically lapped nonwoven material can be enjoyed.

This Summary identifies example features and aspects and is not an exclusive or exhaustive description of disclosed subject matter. Whether features or aspects are included in or omitted from this Summary is not intended as indicative of relative importance of such features or aspects. Additional features are described, explicitly and implicitly, as will be understood by persons of skill in the pertinent arts upon reading the following detailed description and viewing the drawings, which form a part thereof.

### DESCRIPTION OF THE DRAWINGS

FIG. 1 is a schematic side view of a V-Lap nonwoven material.

FIG. 2 is pile of cut pieces of V-Lap nonwoven material which may be used as filling material in consumer goods.

FIG. 3 is an image of a zippered consumer good, e.g., pillow case, filled with cut pieces of V-Lap nonwoven material.

FIG. 4A-4C respectively show a consumer good with a casing and a V-Lap nonwoven liner (FIG. 4A), the open side of the V-lap nonwoven liner being sewn together (FIG. 4B), and the zippered casing over the V-Lap nonwoven liner (FIG. 4C).

FIG. 5A-5C are similar to FIG. 4A-4C except that FIG. 5A shows the opening in a V-Lap nonwoven liner having Velcro (hook and loop) connectors; FIG. 5B shows the V-lap nonwoven liner after closure; and FIG. 5C shows the zippered casing being closed after it fully covers the V-Lap nonwoven liner.

FIG. 6A shows a three layer quilted material which can be used to produce a consumer product in which V-Lap nonwoven pieces are used for cushioning purposes, and FIG. 6B shows a quilted fabric of FIG. 6A shaped as a consumer product with a zippered opening. FIG. 6C shows the consumer product with a zippered liner.

FIG. 7 shows a zippered liner exposed by an open zippered opening of a cover of a consumer product such as, e.g., a pillow case.

### DETAILED DESCRIPTION

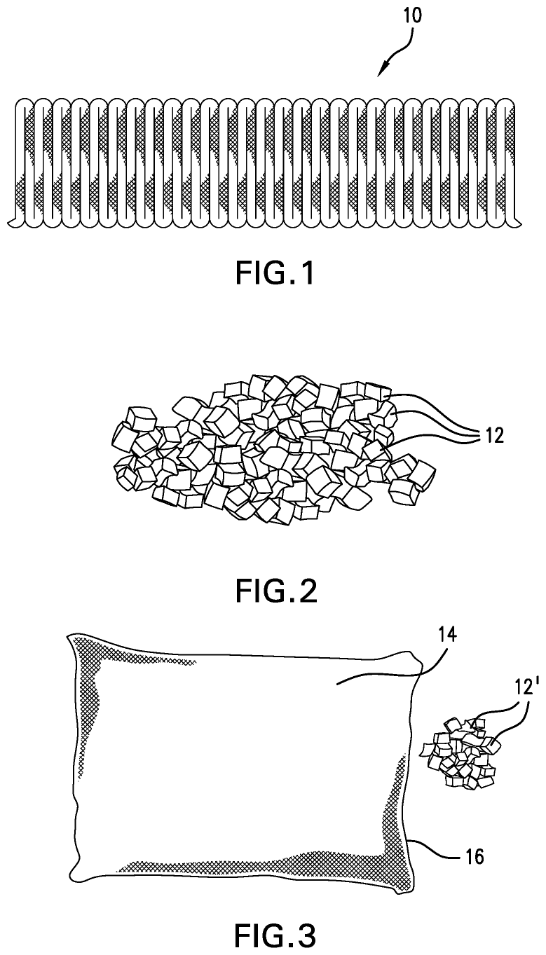

In the practice of the invention, pieces cut from V-Lap nonwoven material are used as filling material for any goods that can use shredded foam as a filling material. Those goods include but not limited to pillows, cushions, sacks, bean bags, and pet mattresses. As shown in FIG. 2, each piece 12 can be the same or different in terms of size and shape (regular or irregular shape). Suitable pieces for filling consumer products will typically range in size from 0.5 cm to 5 cm in length and 0.5 cm to 5 cm in width. The pieces do not need to be rectangular. Rather, they can be spherical, polygonal (square, trapezoidal, hexagonal, etc.), or simply randomly shaped. The V-Lap nonwoven pieces 12 will typically have a vertical thickness of 0.5 cm to 5 cm, where the vertical thickness refers to the height of the pleated section of the V-Lap nonwoven (see FIG. 1).

The V-Lap nonwoven which can be used to make the pieces, can be made from natural or synthetic fibers, and all of the fibers used in the pieces can be the same or different. Typically, the V-Lap nonwoven pieces would be obtained from a sheet of V-Lap nonwoven made with a blend of fibers. Examples of fiber blends for the V-Lap nonwovens that could be used in the practice of this invention include but are not limited to the following:
Elastomeric polyester binder fiber (6 denier×64 mm):High shrink polyester fiber (1.4 denier×51 mm):Low-melt polyester binder fiber (4 denier×51 mm):Regular polyester fiber (6 denier×51 mm)=25:20:10:45
Hollow conjugate polyester fiber (3 denier×51 mm):Elastomeric polyester binder fiber (6 denier×64 mm)=60:40
Hollow polyester fiber (15 denier×51 mm):Low-melt polyester binder fiber (4 denier×51 mm)=60:40
Solid polyester fiber (6 denier×51 mm):Low-melt polyester binder fiber (4 denier×51 mm)=55:45
Hollow conjugate polyester fiber (15 denier×51 mm):Low-melt polyester binder fiber (4 denier×51 mm)=70:30
Solid polyester fiber (15 denier×51 mm):Low-melt polyester binder fiber (4 denier×51 mm)=60:40
Hollow conjugate polyester fiber (3 denier×51 mm):High shrink polyester fiber (1.4 denier×51 mm):Elastomeric polyester binder fiber (6 denier×64 mm)=50:10:40
Hollow conjugate polyester fiber (3 denier×51 mm):Hollow conjugate polyester fiber (15 denier×51 mm):Elastomeric polyester binder fiber (6 denier×64 mm):Low-melt polyester binder fiber (4 denier×51 mm)=50:25:15:10

The vertically lapped (V-Lap) nonwoven can be chemically treated or untreated. The chemical treatment can be done by the method described on US 2020/0378057 A1 which is herein incorporated by reference. The V-Lap nonwoven can be treated with various chemicals to provide various functions. Exemplary chemicals include but not limited to water/oil repellents, antimicrobials, flame retardants, microencapsulated scents, microencapsulated cosmetics, microencapsulated essential oils, microencapsulated PCM (Phase Change Material), probiotics, odor control agents, photocatalytic agents, UV absorbers, anti-allergens, probiotics, hydrophilic agents, hand modifying agents, antistatic agents, insect repellents, and ceramics that emit far infrared and/or negative ions. The chemical formulations may include two or more different agents and/or two or more of the same class of agents (e.g., two different UV absorbers and one antistatic agent).

FIG. 3 shows a cloth case 14 filled with pieces of V-Lap nonwoven 12′ similar to those shown in FIG. 2, but preferably treated with an agent such as PCM. In FIG. 3 each piece 12′ is around 2 cm×2 cm×2.5 cm and is treated with, for example, microencapsulated PCM to give a cooling effect. A standard size zippered pillow case can be filled with 300-700 grams of pieces 12′, depending on how much support is desired by the user. Preferably, the case 14 has a zippered opening 16 which allows the user or the manufacturer to add or remove varying amounts of V-Lap nonwoven pieces 12′. The opening could also be controlled by a zip loc, or Velcro feature. Furthermore, it should be recognized that the case 14 simply represents the outer portion of most any consumer product, and could take the form of a pet bed, a sack, a bean bag, or a chair cushion (such as used on a sofa), and is merely shown as a standard size pillow case for exemplary purposes. In most cases, the case 14 can be a woven or knitted cloth material, such as that used in bedding or the like; however, the case 14 may be made by synthetic materials such as polyurethane (PU) and polyvinylchloride (PVC) (both of which are often used to make artificial leather). In addition, other materials such as foam pieces and/or fiberfills (natural or synthetic), etc. may be inserted inside the case 14 with the V-Lap nonwoven pieces 12′. Moreover, that the V-Lap nonwoven pieces 12′ need not be chemically treated, and could be untreated (such as is shown in FIG. 2).

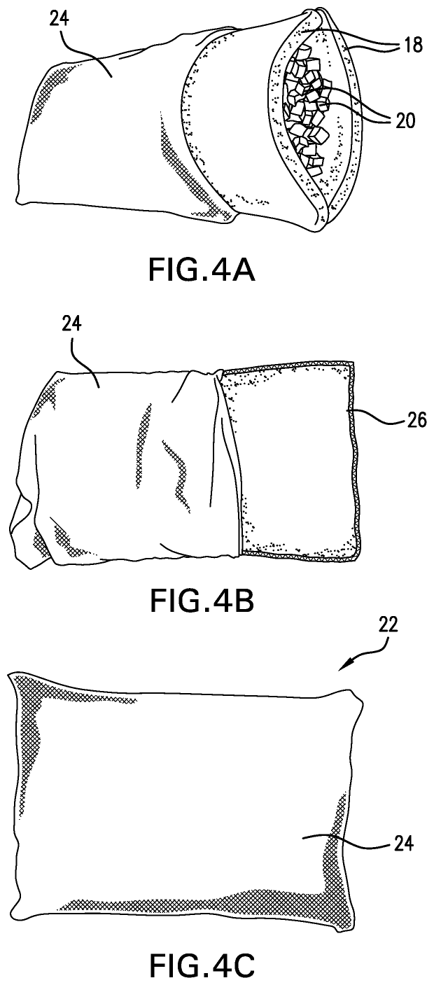

FIGS. 4A-4C show a variation on the arrangement of FIG. 3 wherein a cushion layer 18 is used to create an interior space or volume in which cut pieces of V-Lap nonwoven 20 are positioned in a consumer product 22. The cushion layer 18 may be a cross-lapped nonwoven, a vertically lapped nonwoven, or a foam layer, and it provides the consumer product 22 with a smoother external surface, or at least the appearance of a smoother surface, which the user will contact or see. The cushion layer 18, like the pieces of V-Lap nonwoven 20, may be untreated or treated with one or more chemicals to provide desired functions, examples of which are discussed above in the context of treatment of the V-Lap nonwoven from which the cut pieces are made. If both the V-Lap nonwoven pieces 20 and the cushion layer 18 are treated, they need not be treated with the same chemicals. Similarly, either the V-Lap nonwoven pieces 20 or the cushion layer 18 can be untreated. Further, the V-Lap nonwoven pieces 20 may be used alone inside the consumer product or other materials such as foam pieces and/or fiberfills (natural or synthetic), etc. may be inserted inside the consumer product 22 together with the V-Lap nonwoven pieces 20.

As an exemplary application, FIGS. 4A-4C show a standard sized pillow case 24 being fitted over the cushion layer 18 which is sewn together on three sides. FIG. 4B shows that after filling the inside space with approximately 350 grams of V-Lap nonwoven pieces 20, the fourth side 26 of the cushion layer is sewn together. Thus, the FIG. 4A-4C embodiment show a consumer product 22 where the amount of V-Lap nonwoven pieces is determined by the manufacturer, and the consumer will not be able to easily add or subtract V-Lap nonwoven pieces 20 therefrom. In FIG. 4C the open end of the pillow case 24 is closed. This can be accomplished by sewing the open end, using a zipper closure, or other suitable closure (snaps, Velcro, hooks, etc.) at the open end. Having the open end secured by a reversible closure such as a zipper will allow the pillow case 24 to be washed while the cushion layer 18 remains assembled (as shown in FIG. 4B) with the V-Lap nonwoven pieces stored therein.

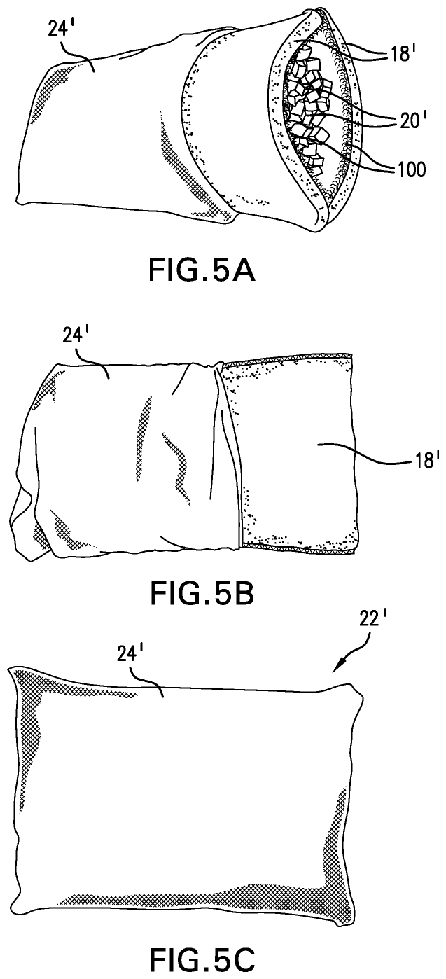

FIGS. 5A-5C show a similar manufacturing process to FIGS. 4A-4C, except that FIG. 5A, shows the open sides of the cushion layer 18′ are securable by Velcro connections 100. FIGS. 5A-5B show that on filling the interior of the cushion layer 18′ with V-Lap nonwoven pieces 20′ and then closing the connections 100, the pillow case 24′ is then pulled over the cushion layer and V-Lap nonwoven pieces, and, preferably has its open end secured by a zipper or other suitable connector (FIG. 5C). The advantage of this process is that the interior of the consumer product 22′ remains accessible to the consumer, and he or she can add or subtract V-Lap nonwoven pieces 20′ from the interior to achieve the support and/or firmness desired. Instead of Velcro connection 100, a zipper can be used. As discussed above, other materials such as foam pieces and/or fiberfills (natural or synthetic), etc. may be inserted inside the pillow together with the V-Lap nonwoven pieces 20′.

In most embodiments of consumer products according to the invention, the outer case could be a simple such as knitted fabric casing with a zipper. Alternatively, the outer case could be a quilted fabric. In still other embodiments, a vertically lapped nonwoven layer can be positioned between a top fabric and bottom scrim or other fabric, and all layers are quilted together. In most applications, the outer case will be zippered and will allow pieces of V-Lap nonwoven to be inserted directly within the outer case, or will allow a liner or middle bag which encases, and is filled with the pieces of cut up V-Lap nonwoven to be inserted in the outer case. Use of a liner to hold the cut pieces of V-Lap nonwoven allows easy removal of the liner and cut pieces of V-Lap nonwoven material from the outer case of the pillow so that, for example, the outer case can be washed. In addition, including a zipper on the liner allows V-Lap nonwoven pieces to be added to or subtracted from the interior of the liner to adjust for desired support or softness.

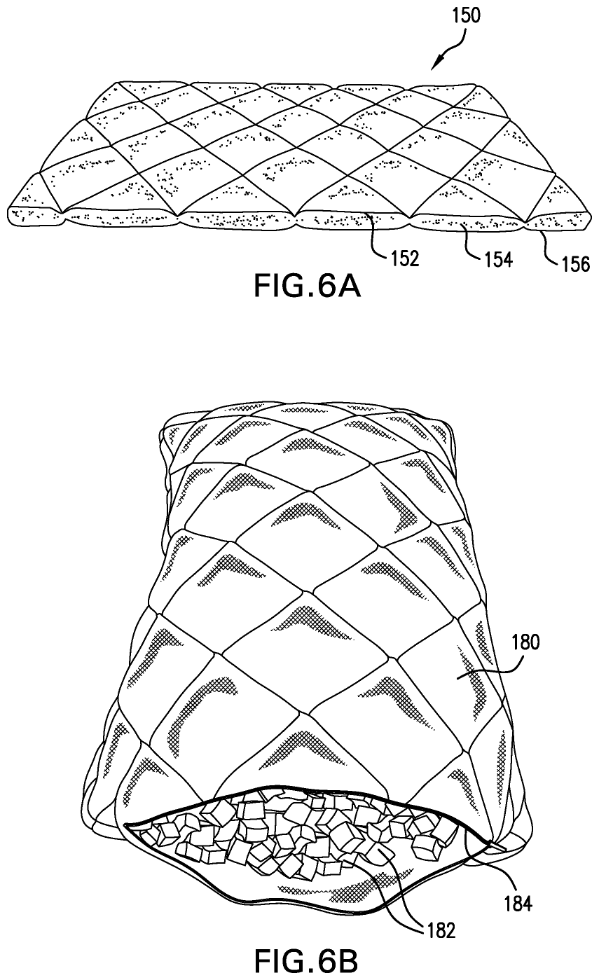

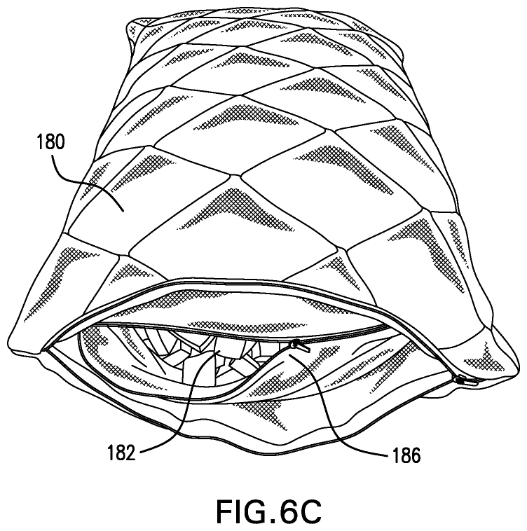

FIG. 6A shows a quilted fabric 150 having a top layer 152 overlying a layer of cushioning material 154, which is preferably vertically lapped nonwoven but could be cross-lapped nonwoven, fiber batting, or foam, which overlies a thin layer of scrim 156. The quilted fabric material 150 of FIG. 6A may be made by quilting all three layers together: top 152 (e.g., a knitted fabric), middle 154 (e.g., a layer of V-Lap nonwoven), and bottom 156 (scrim, e.g., thin spunbond polyester or polypropylene nonwoven).

In the embodiments of FIGS. 4A, 5A, and 6A, the cushioning layer 18, 18′ or 154, may have a thickness of 0.5 cm to 2.5 cm. Its main function is to provide a smooth appearance of the surface of the consumer product. While foam may be used, use of V-Lap or cross-lapped nonwoven can provide advantages in terms of weight of the material, and air flow which would enable the user to, for example, sleep “cooler” rather than “hot” which is associated with foam material.

The quilted fabric 150 in FIG. 6A can be formed as the outer casing of a consumer product such as a pillow case 180 as is shown by FIG. 6B. The pillow case 180 is filled with cut pieces of V-Lap nonwoven 182. As discussed above, the pieces of V-Lap nonwoven 182 can be untreated or chemically treated with one or more agents to achieve certain properties. In addition, the V-Lap nonwoven pieces can be of uniform shape and size or be randomly shaped and sized with the pieces generally ranging from 0.5 to 5 cm on a side, or more preferably 0.5 to 2.5 or 3 cm on a side. In addition, other materials such as foam pieces and/or fiberfills (natural or synthetic), etc. may be inserted inside the pillow case 180 together with the V-Lap nonwoven pieces 182. As shown in FIG. 6B, preferably the interior of the pillow case 180 is made accessible by a zippered opening 184 so that more or less pieces of V-Lap nonwoven can be inserted or retrieved from inside the pillow case 180. The use of V-Lap nonwoven 154 (see FIG. 6A) in the quilted fabric 150 can provide for a more air flow under the head of the user. The use of V-Lap nonwoven pieces as filler material and in the fabric 150 makes for a much lighter pillow than foam, and with improved breathability compared to foam.

While FIG. 6B shows V-Lap nonwoven pieces 182 within an outer housing 180 formed from quilted fabric 150, in some applications it is desirable to secure the V-Lap nonwoven pieces in an inner bag or liner. FIG. 6C shows the zippered pillow case 180 having a zippered inner liner or bag 186 and V-Lap nonwoven pieces 182 are filled in the zippered liner 186. In addition, other materials such as foam pieces and/or fiberfills (natural or synthetic), etc. may be inserted inside the liner 186 together with the V-Lap nonwoven pieces 182.

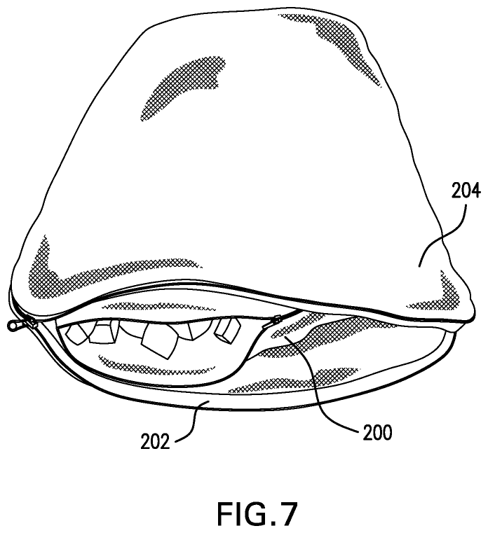

FIG. 7 shows a zippered liner or bag 200 within the zippered opening 202 of an outer cover 204. Storing the V-Lap nonwoven pieces in the zippered liner 200 allows the user to easily remove the outer cover 204 for cleaning or other purposes, while retaining the V-Lap nonwoven pieces neatly within the inner liner or bag 200. FIG. 7 also shows that the outer cover 204 needs not be a quilted fabric such as that shown in FIG. 6B. Rather, in FIG. 7, the outer cover 204 may be, for example, a simple knitted fabric pillow case.

1. A pillow, comprising:
a pillow case having an interior; and
a plurality of pieces of vertically lapped nonwoven material which at least partially fill said interior of said pillow case.

2. The pillow of claim 1 wherein the plurality of pieces of vertically lapped nonwoven material are not treated with chemicals.

3. The pillow of claim 1 wherein the plurality of pieces of vertically lapped nonwoven material are chemically treated with one or more of water/oil repellents, antimicrobials, flame retardants, microencapsulated scents, microencapsulated cosmetics, microencapsulated essential oils, microencapsulated phase change materials (PCMs), probiotics, odor control agents, photocatalytic agents, UV absorbers, anti-allergens, probiotics, hydrophilic agents, hand modifying agents, antistatic agents, insect repellents, and ceramics that emit far infrared and/or negative ions.

4. The pillow of claim 1 further comprising a cushion layer lining the interior of the pillow case which keeps the plurality of pieces of vertically lapped nonwoven material from contacting a surface of said interior of said pillow case.

5. The pillow of claim 4 wherein said cushion layer is at least one of cross-lapped nonwoven material, vertically lapped nonwoven material, and foam material.

6. The pillow of claim 4 wherein said cushion layer is vertically lapped nonwoven material.

7. The pillow of claim 4 wherein the cushion layer is sewn closed on all sides to maintain the plurality of pieces of vertically lapped nonwoven material within an interior volume defined by the cushion layer which is within the interior of the pillow case.

8. The pillow of claim 4 wherein the cushion layer is treated with one or more chemicals.

9. The pillow of claim 4 wherein the cushion layer holds the plurality of pieces of vertically lapped nonwoven material within an interior volume defined by the cushion layer, and wherein the cushion layer includes at least one opening which can be selectively opened and closed.

10. The pillow of claim 9 wherein the opening is a zippered opening.

11. The pillow of claim 1 further comprising an inner liner positioned in the interior of the pillow case.

12. The pillow of claim 11 wherein the inner liner keeps the plurality of pieces of vertically lapped nonwoven material from contacting a surface of said interior of said pillow case.

13. The pillow of claim 11 wherein the inner liner comprises a selectively openable and closeable opening.

14. The pillow of claim 13 wherein the selectively openable and closeable opening comprises a zipper.

15. The pillow of claim 13 wherein the selectively openable and closeable opening comprises a hook and loop material.

16. The pillow of claim 1 wherein the pillow case is constructed of quilted material which includes a top layer, a middle layer made of a cushioning material, and a bottom layer, wherein the bottom layer forms an inside of the pillow and the top layer forms an external surface of the pillow.

17. The pillow of claim 16 further comprising an inner liner positioned within the interior.

18. The pillow of claim 1 wherein each of the plurality of pieces of vertically lapped nonwoven have dimensions ranging from 0.5 to 5 cm on a side, and a pleated height dimension ranging from 0.5 to 5 cm.

19. The pillow of claim 1 wherein the plurality of pieces of vertically lapped nonwoven in aggregate have a weight ranging from 300 to 700 grams.

20. The pillow of claim 1 further comprising one or more of foam pieces, and fiberfills, positioned within the interior of said pillow case together with said plurality of pieces of vertically lapped nonwoven material.

21. The pillow of claim 1 wherein the plurality of pieces of vertically lapped nonwoven material are cut pieces.

22. The pillow of claim 1 wherein the pillow case has an opening which is selectively opened and closed.

23. The pillow of claim 22 wherein the opening is a zippered opening.

24. A consumer product, comprising:
a outer casing defining an interior volume; and
a plurality of pieces of vertically lapped nonwoven material which at least partially fill the interior volume of the outer casing.

25. The consumer product of claim 24 wherein the inner volume of the outer casing is fillable with different volumes of the plurality of pieces of vertically lapped nonwoven material.

26. The consumer product of claim 24 wherein each of the plurality of pieces of vertically lapped nonwoven have dimensions ranging from 0.5 to 5 cm on a side, and a pleated height dimension ranging from 0.5 to 5 cm.

27. The consumer product of claim 24 wherein the plurality of pieces of vertically lapped nonwoven material are not treated with chemicals.

28. The consumer product of claim 24 wherein the plurality of pieces of vertically lapped nonwoven material are chemically treated with one or more of water/oil repellents, antimicrobials, flame retardants, microencapsulated scents, microencapsulated cosmetics, microencapsulated essential oils, microencapsulated phase change materials (PCMs), probiotics, odor control agents, photocatalytic agents, UV absorbers, anti-allergens, probiotics, hydrophilic agents, hand modifying agents, antistatic agents, insect repellents, and ceramics that emit far infrared and/or negative ions.

29. The consumer product of claim 24 wherein the outer casing and the plurality of pieces of vertically lapped nonwoven are configured to function as at least one of a pillow, cushion, sack, bean bag, or pet mattress.

30. The consumer product of claim 24 further comprising a zippered opening in the outer casing which permits access inside the interior volume.

31. The consumer product of claim 24 further comprising an inner liner positioned in the interior volume of the outer casing.

32. The consumer product of claim 24 wherein the inner liner is a selectively openable and closeable opening.

33. The consumer product of claim 32 wherein the inner liner keeps the plurality of pieces of vertically lapped nonwoven material from contacting a surface of said interior volume of said outer casing.

34. The consumer product of claim 32 wherein the inner liner comprises a selectively openable and closeable opening.

35. The consumer product of claim 34 wherein the selectively openable and closeable opening comprises a zipper.
